(19) United States
(12) Patent Application Publication
(10) Pub. No.: US 2026/0017794 A1
(43) Pub. Date: Jan. 15, 2026

(54) METHODS AND SYSTEMS FOR PRESENTING TEETH MORPHOLOGY

(71) Applicant: Get-Grin Inc., Airmont, NY (US)

(72) Inventors: Jonathan LIPNIK, Ramat-Gan (IL); Alon Luis Lipnik, Tel-Aviv (IL); Yarden Eilat-Bloch, Haifa (IL); Adam Benjamin Schulhof, New City, NY (US)

(21) Appl. No.: 19/287,337

(22) Filed: Jul. 31, 2025

Related U.S. Application Data
(63) Continuation of application No. PCT/US2024/013865, filed on Jan. 31, 2024.
(60) Provisional application No. 63/442,465, filed on Feb. 1, 2023.

(51) Int. Cl. G06T 7/00; A61C 8/00

(52) U.S. Cl. CPC G06T 7/0014; A61C 8/00; G06T 2207/20036; G06T 2207/30036; G06T 2207/30204

(57) ABSTRACT

Described herein are devices, systems, and methods for presenting morphological structures of a subject, comprising
(a) providing one or more intraoral videos or images of the subject, wherein the one or more intraoral videos or images comprise at least a portion of the tooth of the subject;
(b) providing a dental imaging image, wherein the dental imaging image comprises (i) at least a portion of the tooth and (ii) the morphological structure of the tooth not visible in the one or more intraoral videos or images;
(c) matching the tooth of the one or more intraoral videos or images with the corresponding tooth of the dental imaging image; and
(d) adding a marking showing the morphological structure of the tooth to the one or more intraoral videos or images.

### CROSS-REFERENCE TO RELATED APPLICATIONS

This application is a Continuation of International Patent Application No. PCT/US24/13865, filed Jan. 31, 2024, which claims benefit of U.S. Provisional Application No. 63/442,465, filed Feb. 1, 2023, each of which is incorporated herein by reference in its entirety.

### TECHNICAL FIELD

The present invention, in at least some embodiments, relates to methods and system for dental assessment, and more specifically to methods and system for presenting teeth morphology.

### BACKGROUND

Dental professionals may treat and monitor a patient's dental condition based on in-person visits. Treatment and monitoring of a patient's dental condition may require preforming a dental imagining to provide the dentist penetration look of the teeth and jaw's condition. The quality of treatment and the accuracy of monitoring may vary depending on availability of such dental imaging. In some cases, suboptimal treatment outcomes may result if a patient is unable or unwilling to schedule regular visits that can provide dental imaging.

### SUMMARY

Recognized herein is a need for dental monitoring solutions to allow dental assessment, optionally remote dental assessment, without requiring a dental professional to be physically present with the patient. Some dental professionals may use conventional teledentistry solutions to accommodate patients' needs and schedules. However, such conventional teledentistry solutions may provide inadequate levels of supervision. Further, such conventional teledentistry solutions may be limited by an inaccurate or insufficient monitoring of a patient's dental condition based on one or more photos taken by the patient, if the photos do not adequately capture various intraoral features.

The present disclosure provides methods and system for dental assessment, such as remote dental assessment. As used herein, the term “remote dental assessment” may refer to assessments conducted by remote personnel and may refer to the acquisition of one or more intraoral videos and/or intraoral images that can be assessed using a remote computing device, or can be sent to different remote locations for assessment. The methods and systems disclosed herein may provide a convenient solution and user experience for dental assessment presentation, in some embodiments, remote assessment, optionally enabling patients to capture one or more intraoral videos or images using a mobile device such as a smartphone. The methods and system disclosed herein, according to some embodiments, may provide dentists with a teeth morphology of the patient's dental condition based on one or more dental scans captured remotely by the patient.

In an aspect, provided herein is a method for presenting morphologic structure of a tooth of a subject, comprising: (a) providing one or more intraoral videos or images of the subject, wherein the one or more intraoral videos or images comprise at least a portion of the tooth of the subject; (b) providing a dental imaging image, wherein the dental imaging image comprises (i) at least a portion of the tooth and (ii) the morphological structure of the tooth not visible in the one or more intraoral videos or images; (c) matching the tooth of the one or more intraoral videos or images with the corresponding tooth of the dental imaging image; and (d) adding a marking showing the morphological structure of the tooth to the one or more intraoral videos or images.

In some cases, the one or more intraoral videos or images comprise a dental scan. In some cases, the one or more intraoral videos or images are acquired using a mobile digital camera and a hollow tubular adapter, and a first opening of the hollow tubular adapter is configured to attach to the mobile digital camera and a second opening of the hollow tubular adapter is configured to contact lips of the subject.

In some cases, in (c), the tooth is identified in the one or more intraoral videos or images using automatic segmentation. In some cases, the dental imaging image is of the same subject as the one or more intraoral videos or images. In some cases, the dental imaging image is selected from the group consisting of X-ray, magnetic resonance imaging (MRI), computed tomography (CT), transillumination, and fluorescent imaging.

In some cases, the matching in (c) comprises comparing a visible part of the tooth from the one or more intraoral videos or images to the dental imaging image. In some cases, the matching in (c) comprises adjusting a visible part of the tooth from the one or more intraoral videos or images to match the tooth in the dental imaging image. In some cases, the matching in (c) comprises adjusting the tooth from the dental imaging image to match a visible part of the tooth in the one or more intraoral videos or images. In some cases, matching in (c) comprises fitting a perspective of a visible part of a tooth in the one or more intraoral videos or images to the tooth in the dental imaging image. In some cases, the matching in (c) comprises fitting a perspective of the tooth in the dental imaging image to a visible part of a tooth in the one or more intraoral videos or images.

In some cases, the morphological structure comprises at least part of a contour of the tooth. In some cases, the morphological structure comprises at least part of a root of the tooth. In some cases, the marking in (d) of the morphological structure is added to the base of the one or more intraoral videos or images. In some cases, the marking in (d) of the morphological structure is added on a layer, wherein the layer can be layered on top of the one or more intraoral videos or images.

In some cases, the tooth is an incisor, canine, pre-molar, or molar. In some cases, the tooth is an incisor. In some cases, the tooth is a canine. In some cases, the tooth is a pre-molar. In some cases, the tooth is a molar. In some cases, the subject is a child.

In some cases, the method further comprises identifying an unerupted tooth in the dental imaging image. In some cases, the method further comprises adding the identified unerupted tooth to the one or more intraoral videos or images. In some cases, the method further comprises adding bone density data identified from the dental imaging image to the one or more intraoral videos or images. In some cases, the method further comprises adding at least part of a maxilla bone contour identified from the dental imaging image to the one or more intraoral videos or images. In some cases, the method further comprises adding at least part of a mandible bone contour identified from the dental imaging image to the one or more intraoral videos or images. In some cases, the method further comprises adding at least part of a dental alveoli identified from the dental imaging image to the one or more intraoral videos or images.

In some cases, the one or more intraoral videos or images and the dental imaging image comprise more than one tooth. In some cases, the method further comprises repeating steps (a)-(d) for an additional tooth in the one or more intraoral videos or images and the dental imaging image. In some cases, the method further comprises providing additional intraoral videos or images of the subject and adding a marking showing the identified morphological structure of the tooth to the additional intraoral videos or images of the subject. In some cases, the one or more intraoral images or videos comprise a panoramic dental image.

In another aspect, provided herein is a system for presenting a morphologic structure of a tooth of a subject, comprising: a processor; a storage element connected to the processor; encoded instructions stored in the storage element, wherein the encoded instructions when implemented by the processor, configure the system to: (a) receive one or more intraoral videos or images of the subject, wherein the one or more intraoral videos or images comprise at least a portion of the tooth of the subject; (b) receive a dental imaging image, wherein the dental imaging image comprises (i) at least a portion of the tooth and (ii) the morphological structure of the tooth not visible in the one or more intraoral videos or images; (c) match the tooth of the one or more intraoral videos or images with the corresponding tooth of the dental imaging image; and (d) add a marking showing the morphological structure of the tooth to the one or more intraoral videos or images.

In some cases, the one or more intraoral videos or images comprise a dental scan. In some cases, the one or more intraoral videos or images are acquired using a mobile digital camera and a hollow tubular adapter, and a first opening of the hollow tubular adapter is configured to attach to the mobile digital camera and a second opening of the hollow tubular adapter is configured to contact lips of the subject.

In some cases, in (c), the tooth is identified in the one or more intraoral videos or images using automatic segmentation. In some cases, the dental imaging image is of the same subject as the one or more intraoral videos or images. In some cases, the dental imaging image is selected from the group consisting of X-ray, magnetic resonance imaging (MRI), computed tomography (CT), transillumination, and fluorescent imaging.

In some cases, the matching in (c) comprises comparing a visible part of the tooth from the one or more intraoral videos or images to the dental imaging image. In some cases, the matching in (c) comprises adjusting a visible part of the tooth from the one or more intraoral videos or images to match the tooth in the dental imaging image. In some cases, the matching in (c) comprises adjusting the tooth from the dental imaging image to match a visible part of the tooth in the one or more intraoral videos or images. In some cases, matching in (c) comprises fitting a perspective of a visible part of a tooth in the one or more intraoral videos or images to the tooth in the dental imaging image. In some cases, the matching in (c) comprises fitting a perspective of the tooth in the dental imaging image to a visible part of a tooth in the one or more intraoral videos or images.

In some cases, the morphological structure comprises at least part of a contour of the tooth. In some cases, the morphological structure comprises at least part of a root of the tooth. In some cases, the marking in (d) of the morphological structure is added to the base of the one or more intraoral videos or images. In some cases, the marking in (d) of the morphological structure is added on a layer, wherein the layer can be layered on top of the one or more intraoral videos or images.

In some cases, the tooth is an incisor, canine, pre-molar, or molar. In some cases, the tooth is an incisor. In some cases, the tooth is a canine. In some cases, the tooth is a pre-molar. In some cases, the tooth is a molar. In some cases, the subject is a child.

In some cases, the method further comprises identifying an unerupted tooth in the dental imaging image. In some cases, the method further comprises adding the identified unerupted tooth to the one or more intraoral videos or images. In some cases, the method further comprises adding bone density data identified from the dental imaging image to the one or more intraoral videos or images. In some cases, the method further comprises adding at least part of a maxilla bone contour identified from the dental imaging image to the one or more intraoral videos or images. In some cases, the method further comprises adding at least part of a mandible bone contour identified from the dental imaging image to the one or more intraoral videos or images. In some cases, the method further comprises adding at least part of a dental alveoli identified from the dental imaging image to the one or more intraoral videos or images.

In some cases, the one or more intraoral videos or images and the dental imaging image comprise more than one tooth. In some cases, the method further comprises repeating steps (a)-(d) for an additional tooth in the one or more intraoral videos or images and the dental imaging image. In some cases, the method further comprises providing additional intraoral videos or images of the subject and adding a marking showing the identified morphological structure of the tooth to the additional intraoral videos or images of the subject. In some cases, the one or more intraoral images or videos comprise a panoramic dental image.

In some cases, the method further comprises subsequent to (d), saving the intraoral videos or images with the marking. In some cases, the method further comprises adding the one or more intraoral videos or images, the dental imaging image, or the one or more intraoral videos or images with the marking obtained in (d) to a machine learning algorithm.

In another aspect, provided herein is a method to present a rendering of a root of a tooth of a subject, comprising: (a) conducting a dental scan of a subject; (b) processing the dental scan to identify a crown shape and location of at least one tooth; (c) based on the crown shape and the location of the tooth identified in (b), retrieving from a dataset comprising teeth morphological structures, a root shape with the greatest probability of matching the identified tooth; and (d) adding the root shape to the identified tooth in the dental scan, thereby obtaining the rendering of the root of the tooth of the subject.

In some cases, the dental scan is acquired using a mobile digital camera and a hollow tubular adapter, wherein a first opening of the hollow tubular adapter is configured to attach to the mobile digital camera, and wherein a second opening of the hollow tubular adapter is configured to contact lips of the subject.

In some cases, the identifying in (b) or the retrieving in (c) is performed by a human. In some cases, the identifying in (b) or the retrieving in (c) is performed automatically by a computer software. In some cases, the identifying in (b) comprises 3D modeling of the crown. In some cases, the identifying in (b) comprises segmentation.

In some cases, the root shape comprises at least some subject properties. In some cases, in (c), the root shape is further based on root shapes of one or more teeth neighboring the tooth. In some cases, in (c), the root shape is further based on root shapes that were previously identified as having greatest probability of matching the user. In some cases, the adding in (d) comprises an assessment of unerupted teeth. In some cases, the adding in (d) comprises an assessment of bone density. In some cases, the adding in (d) comprises an assessment of least part of a maxilla bone contour of the subject. In some cases, the adding in (d) comprises an assessment of least part of a mandible bone contour of the subject. In some cases, the adding in (d) comprises an assessment of least part of a dental alveoli of the subject.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system of the present invention involves performing or completing selected tasks or steps manually, automatically, or a combination thereof. Moreover, according to actual instrumentation and equipment of preferred embodiments of methods, apparatus and systems of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

In order to understand the invention and to see how it may be carried out in practice, embodiments will now be described, by way of non-limiting examples only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 and FIG. 1B is a flow-chart schematically illustrating methods for presenting teeth morphology, in accordance with some embodiments.

FIG. 2 schematically illustrates a process for presenting teeth morphology, in accordance with some embodiments.

FIG. 3 schematically illustrates a process for presenting teeth morphology with optional analyzing results, in accordance with some embodiments.

FIG. 4 schematically illustrates a computer system that is programmed or otherwise configured to implement at least some of the methods disclosed herein, in accordance with some embodiments.

FIG. 5 is a flow-chart schematically illustrating a method to present assessment of a user's dental roots, in accordance with some embodiments.

### DETAILED DESCRIPTION OF EMBODIMENTS

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “real-time,” as used herein, generally refers to a simultaneous or substantially simultaneous occurrence of a first event or action with respect to an occurrence of a second event or action. A real-time action or event may be performed within a response time of less than one or more of the following: ten seconds, five seconds, one second, a tenth of a second, a hundredth of a second, a millisecond, or less relative to at least another event or action. A real-time action may be performed by one or more computer processors.

As used herein, when a numerical value is preceded by the term “about”, the term “about” is intended to indicate +/−10% of that value. Whenever the term “at least.” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The terms “a.” “an,” and “the,” as used herein, generally refer to singular and plural references unless the context clearly dictates otherwise.

### Overview

According to an aspect, the present disclosure provides methods and systems for intraoral assessment. As used herein, “intraoral assessment” may refer to assessment of an appearance or condition of an intraoral region of a subject. The methods and system disclosed herein may provide a convenient presentation of an intraoral assessment such as teeth morphology that include all aspects acquired by the dental scan. The methods and systems disclosed herein may provide dentists and orthodontists or any health care personal with a detailed analysis of the patient's dental condition based on a video or on one or more images of at least one tooth, such as one or more teeth, one or more dental arches or both dental arches of a subject, in some embodiments captured remotely by a user, In some embodiments, the user is the subject. In some embodiments the user is a person other than the subject, present at the same location as the subject and assessment of the captured video or image(s) is performed at a remote location.

As used herein the term “dental scope” or “dental adaptor” refer to a device that can be attached to a camera or mobile phone comprising a camera and enables capturing at least one intraoral image or videos of a subject. The term “dental scope” or “dental adaptor” may refer to a hollow tubular adapter wherein one opening of the hollow tubular adapter is attached to the mobile digital camera and the second opening of the hollow tubular adapter was in contact with the user inner lips and the lips lay on the outer of the second opening of the hollow tubular adapter. An example and possible uses can be seen in U.S. patent application Ser. No. 17/336,997.

As used herein, the term “dental scan” refers to intraoral videos or intraoral images, or oral video, or oral images that are the results of using the “dental scope” or “dental adaptor” as attached to a digital camera such as mobile device while acquiring an intraoral video or intraoral image. An example for dental scan, and possible uses, can be seen in U.S. patent application Ser. No. 17/336,997. The intraoral videos or intraoral images or the dental scan provided to the method and systems of the present disclosure may be implemented using a software application that is configured to enable a dental patient to capture videos and/or images of intraoral regions. The software application may be used by a user or a subject (e.g., a dental patient) in conjunction with a mobile device to remotely monitor a dental condition of the subject. The dental condition may comprise a development, a growth, a movement, an appearance, a condition, a physical arrangement, a position, and/or an orientation of the subject's teeth or/and the subject's soft tissues in the oral cavity.

As used herein, “remote monitoring” may refer to monitoring the intraoral region of a subject and/or a condition of an intraoral region of a subject, wherein the monitoring is performed at one or more locations remote from the subject. For example, a dentist or a medical specialist may monitor the intraoral anatomy or intraoral condition at a first location that is different than a second location at which the subject is located. The first location and the second location may be separated by a distance spanning at least 1 meter, 1 kilometer, 10 kilometers, 100 kilometers, 1000 kilometers, or more.

The remote monitoring may be performed by assessing an intraoral condition of the subject using one or more dental scans captured from the subject when the subject is located remotely from the dentist or a dental office. In some cases, the remote monitoring may be performed in real-time such that a dentist is able to assess the dental condition when a subject uses a mobile device to acquire one or more videos or images of one or more intraoral regions in the patient's mouth. The remote monitoring may be performed using equipment, hardware, and/or software that is not physically located at a dental office.

The software application for dental assessment may be configured to run on a mobile device. The mobile device may comprise a smartphone, a tablet, a laptop, or any suitable device that may be used by a patient to capture one or more dental assessments. The software application may be installed on a mobile device of a user. The software application may be a patient-side software application. Alternatively, the software application for dental assessment may be configured to run on a fixed-location device, such as a desktop computer. Alternatively, the software application for dental assessment may be configured to run on a remote location device, such as a compute cloud server or service.

As used herein, the terms “teeth morphology” or “teeth anatomy” generally refers to the structures of any of the hard, bony conical structures of the upper and lower jaws used for chewing. A tooth consists of a crown portion above the gum, a root portion embedded in a socket (alveolus) of the jaw bone, and a neck or cervical constricted region between the crown and root. According to some embodiment the terms “teeth morphology” or “teeth anatomy”, can be represented in three-dimensions (3D) or two-dimension (2D) perspective of tooth morphology.

As used herein, the term “dental imaging”, generally refers to a medical or non-medical imaging that can acquire hard tissue or soft tissues. Examples of “dental imaging” include X-ray, magnetic resonance imaging (MRI), computed tomography (CT), transillumination, and fluorescent imaging. The term “dental imaging image” generally refers to an image acquired with dental imaging.

As used herein, the term “penetration imaging” generally refers to a medical or non-medical imaging that can acquire hard tissue or soft tissues. Example of “penetration imaging” include X-ray, magnetic resonance imaging (MRI), computed tomography (CT), transillumination, and fluorescent imaging. The term “penetration imaging image” generally refers to an image acquired with penetration imaging.

As used herein, the terms “panoramic intraoral presentation”, “panoramic intraoral image” and “panoramic representation” generally refer to an image showing at least part of a dental arch of teeth, made from at least two intraoral video frames or intraoral images with at least one tangent area.

### Methods for Presenting Teeth Morphology

According to an aspect described herein is a method for presenting teeth morphology comprising:
providing user oral video or oral images;
providing user dental imaging image comprising at least one tooth root;
matching the dental imaging image to a at least part of a tooth from the oral video or oral images;
identifying morphological structure of the tooth not visible in oral video or oral images; adding a marking of the identified morphological structure of the tooth to oral video or oral images.

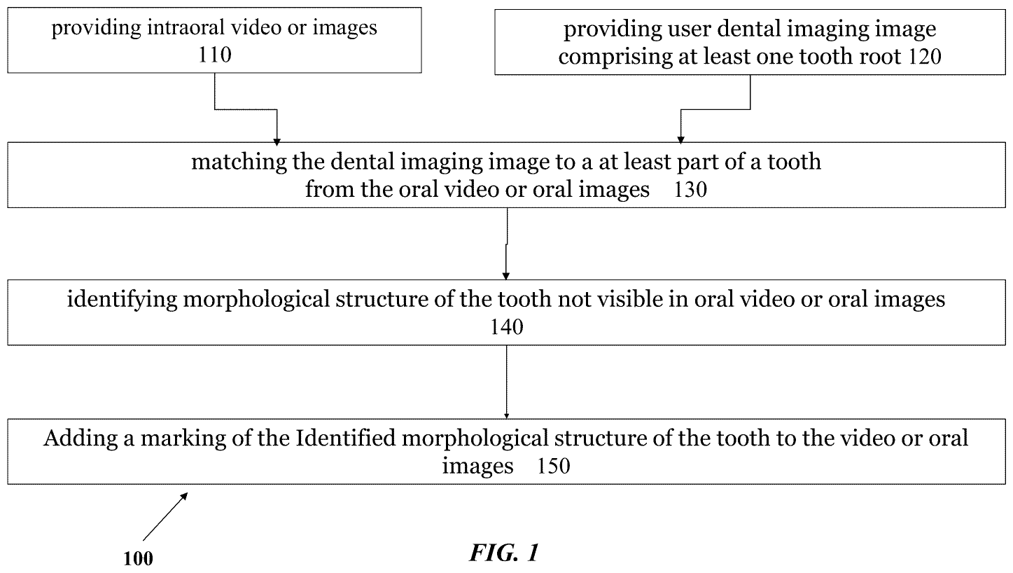

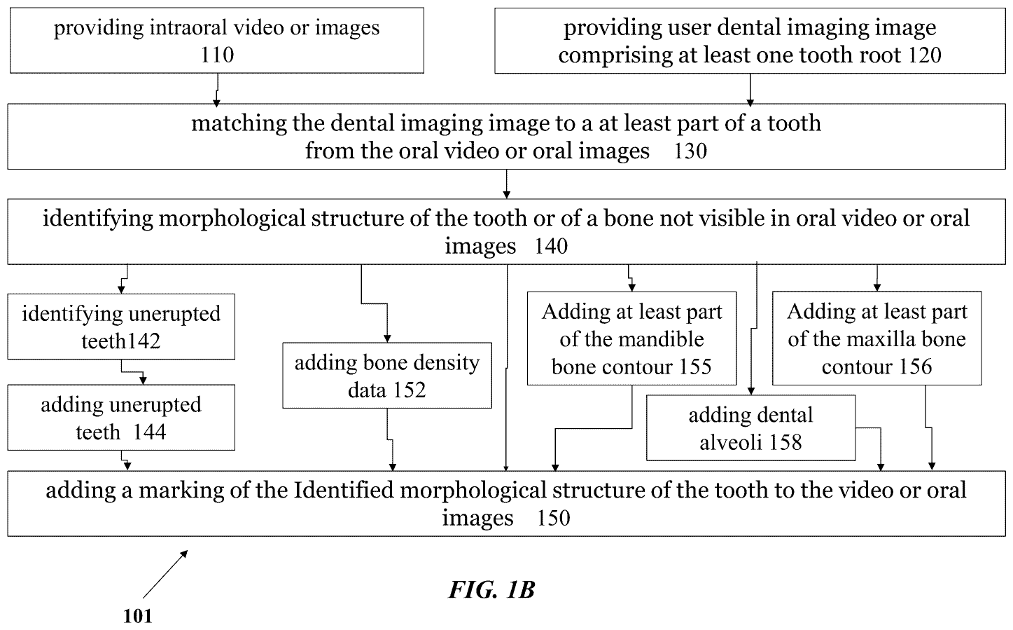

FIG. 1 schematically illustrates a method 100 for presenting teeth morphology, in accordance with some embodiments. The method may include providing intraoral video or images 110 and/or providing user dental imaging images comprising at least one tooth root 120. According to some embodiments, the intraoral video or images and dental imaging images are digital files. According to some embodiments, the digital files can be in any format that represent video or images. In some cases, the method comprises matching 130 the dental imaging images 120 to at least part of a tooth from the oral video or oral images 110, identifying 140 morphological structures of the tooth not visible in oral video or oral images 110, and then adding a marking 150 of the identified morphological structure of the tooth to oral video or oral images 110.

According to some embodiments, the oral video or oral images are dental scans. According to some embodiments, in the dental imaging image, the root and the crown of the tooth are distinguishable.

According to some embodiments, the oral video or oral images were acquired using a mobile digital camera and a hollow tubular adapter. In some cases, one opening of the hollow tubular adapter is attached to the mobile digital camera and another second opening of the hollow tubular adapter is in contact with the user inner lips and the lips lay on the outer of the second opening of the hollow tubular adapter.

According to some embodiments, the teeth are identified in the oral video or oral images or in the dental imaging image using automatic segmentation. According to some embodiments, the teeth are identified manually. According to some embodiments, the oral video or oral images or the dental imaging image are received with the teeth identified.

According to some embodiments, the teeth in the oral video or oral images or in the dental imaging image are identified with human aid.

According to some embodiments, the dental imaging image is of the same user of the oral video or oral images.

According to some embodiments, the dental imaging image is one of X-ray, magnetic resonance imaging (MRI), computed tomography (CT), transillumination, and fluorescent imaging.

According to some embodiments, the oral video or oral images and the dental imaging image are processed. According to some embodiments, the processing includes matching and or identifying morphological structures as teeth and or bones.

According to some embodiments, the matching includes comparing the visible tooth part from the oral video or oral images to the dental imaging image.

According to some embodiments, the matching includes adjusting the visible tooth part in the oral video or oral images to the dental imaging image.

According to some embodiments, the matching includes adjusting the dental imaging image to the visible tooth in the oral video or oral images.

According to some embodiments, the matching includes fitting perspective of the visible tooth part in the oral video or oral images to the dental imaging image.

According to some embodiments, the matching includes fitting perspective of the dental imaging image to the visible tooth part in the oral video or oral images.

According to some embodiments, the identified morphological structure includes at least part of the contour of the tooth.

According to some embodiments, the identified morphological structure includes at least part of the root of the tooth.

According to some embodiments, the identified morphological structure of a tooth can be represented in 3D structure or 2D projection of the 3D structure from selected perspective.

According to some embodiments, the adding a marking of the identified morphological structure is done on the base of the oral video or oral images.

According to some embodiments, the adding a marking of the identified morphological structure is on a layer corresponding to the oral video or oral images. In some cases, the layer is added on top of the oral video or oral images.

According to some embodiments, the tooth is an incisor, canine, pre-molar, or a molar.

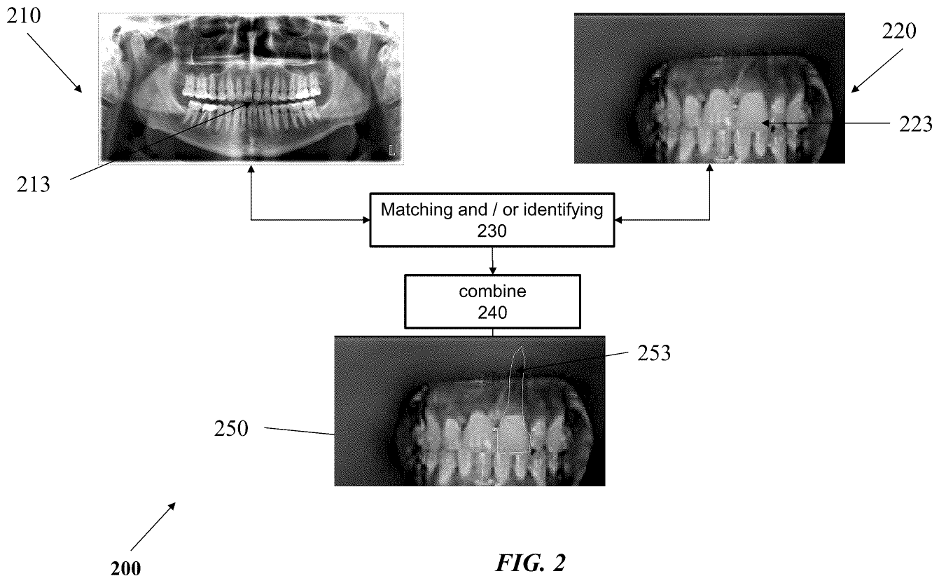

FIG. 2 schematically illustrates an example method 200 for presenting teeth morphology, in accordance with some embodiments. The method includes providing intraoral video frame or image 220 and/or providing user dental imaging image 210 comprising at least one tooth root 213. According to some embodiments, the intraoral video or images and dental imaging images are digital files. According to some embodiments, the digital files can be in any format that represent video or images. According to some embodiments, the digital file is a result of cd scan. In some cases, the method comprises matching/identifying 230 the dental imaging image 210 to a at least part of a tooth from the oral video frame or oral images 220 or identifying 230 morphological structures of the tooth 213 not visible in oral video or oral images 220. In some cases, the method comprises combining 240 the identified morphological structures of the tooth 213 from image 210 to the oral video frame or oral images 220 to tooth 223 then adding a marking 253 of the identified morphological structure of the tooth 213 to the identified tooth 223 into the oral video or oral image 250.

According to some embodiments, the user is a child.

According to some embodiments, the method further comprising identifying unerupted teeth. According to some embodiments the unerupted teeth are presented on the dental imaging image.

According to some embodiments, the method further comprising adding the identified unerupted teeth to the oral video or oral images.

According to some embodiments, the method further comprising adding bone density data identified from the dental imaging image to the oral video or oral images. According to some embodiments, the added bone density data comprises parameter data, color mark or pattern mark that represent bone density variation of the jaws.

According to some embodiments, the method further comprising adding at least part of a maxilla bone contour identified from the dental imaging image to the oral video or oral images. According to some embodiments, the added maxilla bone contour are line or lines marking the identified bone surrounding at least one tooth. According to an embodiment, the added maxilla bone contour is a line or lines representing mark the maxilla bone tops. According to some embodiments, the added maxilla bone contour is a data representing the gap of at least one maxilla top to the gingiva.

According to some embodiments, the method further comprising adding at least part of the mandible bone contour identified from the dental imaging image to the oral video or oral images. According to some embodiments, the added mandible bone contour are line or lines marking the identified bone surrounding at least one tooth. According to an embodiment the added mandible bone contour is a line or lines representing mark the maxilla bone tops. According to some embodiment the added mandible bone contour is a data representing the gap of at least one maxilla top to the gingiva.

According to some embodiments, the method further comprising adding at least part of a dental alveoli identified from the dental imaging image to the oral video or oral images. According to some embodiments, the added alveoli are line or lines marking the identified bone surrounding at least one tooth,

According to some embodiments, the presenting teeth morphology comprises at least more than one tooth.

According to some embodiments, the presenting teeth morphology is compared to the user additional oral video or oral images and adding teeth morphology to the additional user oral video or oral images.

According to some embodiments, the presenting tooth morphology is a panoramic dental image.

FIG. 1B schematically illustrates a method 101 for presenting teeth morphology, in accordance with some embodiments. The method may include providing intraoral video or images 110 and/or providing user dental imaging images comprising at least one tooth root 120. According to some embodiments, the intraoral video or images and dental imaging images are digital files. According to some embodiments, the digital files can be in any format that represents video or images. The method may comprise matching 130 the dental imaging images 120 to a at least part of a tooth from the oral video or oral images 110. The method may comprise identifying 140 morphological structures of the tooth and or the bone not visible in oral video or oral images 110 and then adding a marking 150 of the identified morphological structure of the tooth to oral video or oral images. According to some embodiments, the oral video or oral images can be a panoramic dental image. According to some embodiments, the method can include identifying unerupted teeth 142 and adding the unerupted teeth 144 to oral video or oral images 150. According to some embodiments, the method can include adding bone density 152 to oral video or oral images 150. According to some embodiments, the method can include adding at least part of the mandible contour 155 to oral video or oral images 150. According to some embodiments, the method can include adding at least part of the maxilla contour 156 to oral video or oral images 150. According to some embodiments, the method can include adding at least part of the dental alveoli 158 to oral video or oral images 150.

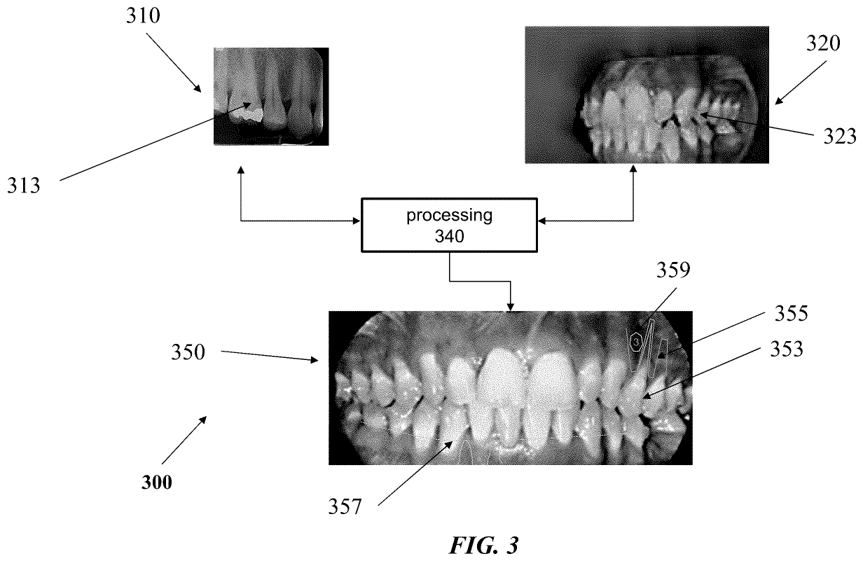

FIG. 3 schematically illustrates an example method 300 for presenting teeth morphology, in accordance with some embodiments. The method can include providing intraoral video frame or image 320 and/or providing user dental imaging image 310 comprising at least one tooth root 313. According to some embodiments, the intraoral video or images and dental imaging images are digital files. According to some embodiments, the digital files can be in any format that represent video or images. According to some embodiments, the digital file is a result of an x-ray. The method may comprise processing 340 the dental imaging image 310 to identify at least part of a morphological structures of the tooth and/or at least part of bone. The processing can include perspective analysis of the identified morphological structures. The method may comprise adding a marking to the a panoramic dental image 350. The added marking can be the morphological structures of the tooth 353 (identified tooth 313 from image 310 and tooth 323 from image 320). The method may comprise marking 355 representing the maxilla contour, marking 357 representing the mandible tops line and or contour, and/or marking 359 representing done density. Each of the marking can be drawn as a line, color, pattern or written data.

### System for Presenting Teeth Morphology

According to an aspect, described herein is a system for presenting teeth morphology comprising:
a processor; a storage element connected to the processor; encoded instruction stored in the storage element, wherein the encoded instructions when implemented by the processor, configure the system to:
receive user oral video or oral images;
receive user dental imaging image comprising at least one tooth;
matching the dental imaging image to a at least part of a tooth from the oral video or oral images;
identifying morphological structure of the tooth not visible in oral video or oral images; and adding a marking of the identify morphological structure of the tooth to oral video or oral images.

According to some embodiments, the received oral video or oral images are dental scans. According to some embodiments, in the dental imaging image, the root and the crown of the tooth are distinguishable.

According to some embodiments, the received oral video or oral images were acquired using a mobile digital camera and a hollow tubular adapter wherein one opening of the hollow tubular adapter is attached to the mobile digital camera and the second opening of the hollow tubular adapter was in contact with the user inner lips and the lips lay on the outer of the second opening of the hollow tubular adapter. According to some embodiments the hollow tubular adapter is similar to the hollow tubular adapter disclosed in U.S. patent application Ser. No. 17/336,997.

According to some embodiments, the teeth are identified in the oral video or oral images or in the dental imaging image using automatic segmentation. According to some embodiments, the teeth are identified manually. According to some embodiments, the teeth in the oral video or oral images or in the dental imaging image are received with the teeth identified.

According to some embodiments, the dental imaging image is of the same user of the oral video or oral images.

According to some embodiments, the dental imaging image is one of X-ray, magnetic resonance imaging (MRI), computed tomography (CT), transillumination, and fluorescent imaging.

According to some embodiments, the oral video or oral images and the dental imaging image are processed. According to some embodiments, the processing includes matching and or identifying morphological structures such as teeth or bones.

According to some embodiments, the matching includes comparing the visible tooth part from the oral video or oral images to the dental imaging image.

According to some embodiments, the matching includes adjusting the visible tooth part in the oral video or oral images to the dental imaging image.

According to some embodiments, the matching includes adjusting the dental imaging image to the visible tooth in the oral video or oral images.

According to some embodiments, the matching includes fitting perspective of the visible tooth part in the oral video or oral images to the dental imaging image.

According to some embodiments, the matching includes fitting perspective of the dental imaging image to the visible tooth part in the oral video or oral images.

According to some embodiments, the identified morphological structure include at least part of the contour of the tooth.

According to some embodiments, the identified morphological structure include at least part of the root of the tooth.

According to some embodiments, the identified morphological structure of a tooth can be represented in 3D structure or 2D projection of the 3D structure from selected perspective.

According to some embodiments, adding a marking of the identified morphological structure is done on the base of the oral video or oral images.

According to some embodiments, adding a marking of the identified morphological structure is on a layer corresponding to the oral video or oral images.

According to some embodiments, the tooth is an incisor, canine, pre-molar, or a molar.

According to some embodiments, the user is a child.

According to some embodiments, the method further comprises identifying unerupted teeth.

According to some embodiments, the method further comprises adding the identified unerupted teeth to the oral video or oral images. According to some embodiments, the unerupted teeth are presented on the dental imaging image.

According to some embodiments, the method further comprises adding bone density data identified from the dental imaging image to the oral video or oral images. According to some embodiments the added bone density data comprises parameter data, color mark or pattern mark that represent bone density variation of the jaws.

According to some embodiments, the method further comprises adding at least part of the maxilla bone contour identified from the dental imaging image to the oral video or oral images. According to some embodiments, the added maxilla bone contour are line or lines marking the identified bone surrounding at least one tooth. According to an embodiment the added maxilla bone contour is a line or lines representing mark the maxilla bone tops. According to some embodiments, the added maxilla bone contour is a data representing the gap of at least one maxilla top to the gingiva.

According to some embodiments, the method further comprises adding at least part of the mandible bone contour identified from the dental imaging image to the oral video or oral images. According to some embodiments, the added mandible bone contour are line or lines marking the identified bone surrounding at least one tooth. According to an embodiment the added mandible bone contour is a line or lines representing mark the maxilla bone tops. According to some embodiments, the added mandible bone contour is a data representing the gap of at least one maxilla top to the gingiva.

According to some embodiments, the method further comprises adding at least part of the dental alveoli identified from the dental imaging image to the oral video or oral images. According to some embodiments, the added alveoli are line or lines marking the identified bone surrounding at least one tooth.

According to some embodiments, the presenting teeth morphology comprise at least more than one morphological structure of the tooth.

According to some embodiments, the presenting teeth morphology is compared to the user additional oral video or oral images and adding teeth morphology to the additional user oral video or oral images.

According to some embodiments, the presenting tooth morphology is a panoramic dental image.

According to some embodiments, all the oral videos or oral images with the added roots and or dental panoramic image saved in a dataset with user properties. According to some embodiments, user properties can include the user age, gender, racial affiliation, family or personal history variety in dental structures or development.

According to some embodiments, all the oral videos or oral images, dental imaging images, oral videos or oral images with the added roots and dental panoramic images are added to a machine learning framework.

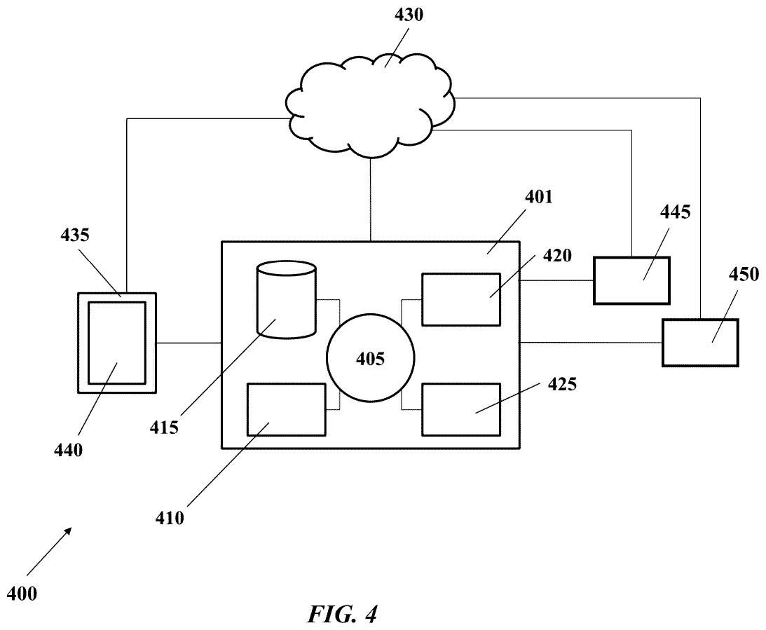

FIG. 4 shows a computer system 401 that is programmed or otherwise configured to implement a method for presenting teeth morphology. The computer system 401 may be configured to, for example, process intraoral videos or images captured using the camera of the mobile device, analyze the videos or images, and presenting teeth morphology. The computer system 401 can be an electronic device of a user or a computer system that is remotely located with respect to the electronic device, or even in the cloud. The electronic device can be a mobile electronic device. The computer system 401 can be a smartphone.

The computer system 401 may include a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk, Solid State drive or equivalent storge unit), communication interface 420 (e.g., network adaptor) for communicating with one or more other systems, and peripheral devices 425, such as cache, other memory, data storage and/or electronic display adaptors. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are located external to the computer system 401 (e.g., on a remote server that is in communication with the computer system 401 through an intranet or the Internet).

The computer system 401 can communicate with one or more remote computer systems through the network 430. For instance, the computer system 401 can communicate with a remote computer system of a user (e.g., a subject, a dental patient, or a dentist). Examples of remote computer systems include personal computers (e.g., portable PC), slate or tablet PC's (e.g., Apple® iPad, Samsung R; Galaxy Tab), telephones, Smart phones (e.g., Apple® iPhone, Android-enabled device, Blackberry®), or personal digital assistants. The user can access the computer system 401 via the network 430.

Methods and systems as described herein can be implemented by way of machine (e.g., computer processor) executable code stored on an electronic storage location of the computer system 401, such as, for example, on the memory 410 or electronic storage unit 415. The machine executable or machine readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a storage unit. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM. DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display 435 that comprises a user interface (UI) 440 for providing, for example, a portal for a subject or a dental patient to view one or more intraoral images or videos captured using a mobile device of the subject or the dental patient. In some cases, the electronic display 435 may be the feedback element providing the generated output, for example displaying message or shape or light in accordance to some embodiments. The portal may be provided through an application programming interface (API). A user or entity can also interact with various elements in the portal via the UI. Examples of UI's include, without limitation, a graphical user interface (GUI) and web-based user interface.

The computer system 401 can include or be in communication with a camera 445 for providing, for example, ability to capture videos or images of the intraoral of a user or a dental patient. Methods and systems of the present disclosure can be implemented by way of one or more algorithms. An algorithm can be implemented by way of software upon execution by the central processing unit 405. The algorithm can, for example, implement a method for presenting teeth morphology. The method may comprise processing videos or images captured using the camera of the mobile device or processing received user oral video or oral images and/or received user dental imaging image and executed to generate output.

The algorithm can, for example, implement a method of machine learning framework for presenting teeth morphology. In order to transfer a given capability into a machine, so-called supervised machine-learning techniques can be employed. Broadly speaking, a training dataset containing input images together with requested output (the “ground-truth”) is assembled. This dataset is assembled from input images which should resemble the expected input images to the machine after deployment as much as possible. The requested output can be any desired output type, e.g image classification, segmentation mask, image augmentation, text etc. The requested output can be gathered by manual human labeling, or by fusing data with other means of data gathering. This dataset is then fed into a machine-learning framework which uses an optimization process to control internal parameters in a model architecture (e.g SVM, neural network, random forest etc.). The optimization process goal is to reduce the error between the machine's output and the ground-truth output for each image in the training dataset. Once the optimization process has reached the required accuracy on the training dataset the machine's performance can be tested on a similar test dataset to validate the performance in real-world settings.

### Method and System to Present Assessment of a User Dental Roots

According to an aspect, described herein is a method to present assessment of a user dental roots comprising:
conducting a dental scan;
processing the dental scan to identify at least one tooth crown shape and location;
retrieving from a dataset comprising teeth morphological structures the best probability root shape of the identified tooth; and
adding the best probability root shape to the identified tooth dental scan.

According to some embodiments, best probability is 50 percentage that the assessed teeth morphological structure will be similar to the user teeth structure. According to some embodiments, best probability is 60 percentage that the assessed teeth morphological structure will be similar to the user teeth structure. According to some embodiments, best probability is 70 percentage that the assessed teeth morphological structure will be similar to the user teeth structure. According to some embodiments, best probability is 80 percentage that the assessed teeth morphological structure will be similar to the user teeth structure. According to some embodiments, best probability is 90 percentage that the assessed teeth morphological structure will be similar to the user teeth structure. According to some embodiments, best probability is 95 percentage that the assessed teeth morphological structure will be similar to the user teeth structure.

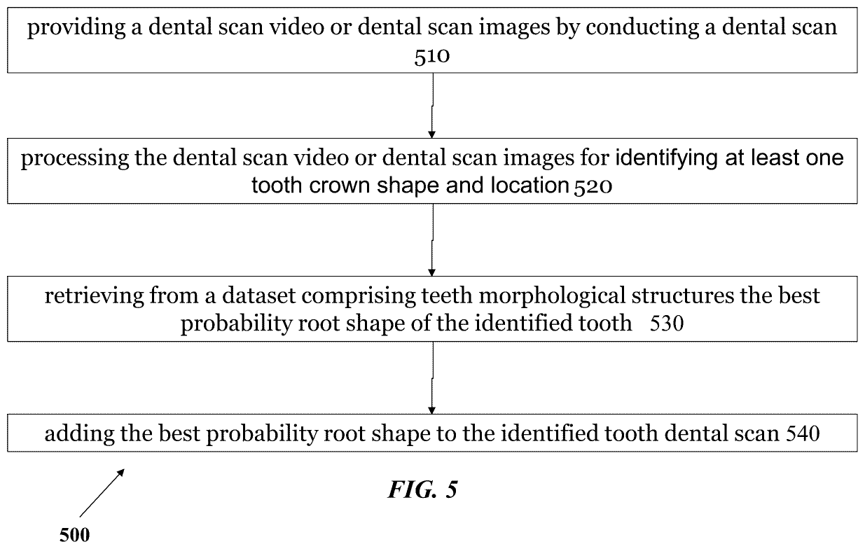

FIG. 5 is a flow-chart schematically illustrating a method to present assessment of a user dental roots, in accordance some embodiments. Method 500 may comprise providing a dental scan video or dental scan images by conducting a dental scan 510. The method may comprise processing the dental scan video or dental scan images for identifying at least one tooth crown shape and location 520. The method may comprise retrieving from a dataset comprising teeth morphological structures the best probability root shape of the identified tooth 530. An example dataset is described herein above. The method may comprise adding the best probability root shape to the identified tooth dental scan 540. According to some embodiments, the identified tooth dental scan 540 can be the provided dental scan 510. According to some embodiments, the identified tooth dental scan 540 can be a different representation of the dental scan 510 as a panoramic dental image or a new image comprising the dental scan 510 and the identified tooth in a separate layer. According to some embodiments, the identified tooth dental scan 540 can be a 3D representation of the dental scan 510 and the best probability root shape of the identified tooth can be a 3D representation of the root shape.

According to some embodiments, the dental scan video or dental scan images were acquired using a mobile digital camera and a hollow tubular adapter. One opening of the hollow tubular adapter can be attached to the mobile digital camera, and a second opening of the hollow tubular adapter can contact the user inner lips, and the lips may lay on the outer of the second opening of the hollow tubular adapter.

According to some embodiments, the identifying and/or retrieving is done by a human.

According to some embodiments, the identifying and/or retrieving is done automatically by a computer software.

According to some embodiments, the identifying and/or retrieving is an outcome of machine learning framework of dataset of identified teeth morphology.

According to some embodiments, the processing comprises 3D modeling of the crown.

According to some embodiments, the processing comprises segmentation.

According to some embodiments, the segmentation of a tooth includes identification of at least one of the neighboring teeth.

According to some embodiments, the dataset is the outcome of a system according to some aspects as described herein, for example, the dataset described in paragraph 162 herein above.

According to some embodiments, the best probability root shape can comprise at least some user properties. According to preferred embodiments, user properties can include the user age, gender, racial affiliation, family or personal history variety in dental structures or development.

According to some embodiments, the best probability root shape comprises consideration of neighboring teeth and the best probability of the neighboring teeth root shape.

According to some embodiments, the best probability root shapes are compared to previous best probability root shapes of the user.

According to some embodiments, the adding comprises an assessment of unerupted teeth.

According to some embodiments, the adding comprises an assessment of bone density.

According to some embodiments, the adding comprises an assessment of least part of the maxilla bone contour.

According to some embodiments, the adding comprises an assessment of least part of the mandible bone contour.

According to some embodiments, the adding comprises an assessment of least part of the dental alveoli.

Described herein is a system that can perform any of the disclosed methods.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense.

Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for presenting morphologic structure of a tooth of a subject, comprising:
(a) providing one or more intraoral videos or images of the subject, wherein the one or more intraoral videos or images comprise at least a portion of the tooth of the subject;
(b) providing a dental imaging image, wherein the dental imaging image comprises (i) at least a portion of the tooth and (ii) the morphological structure of the tooth not visible in the one or more intraoral videos or images;
(c) matching the tooth of the one or more intraoral videos or images with the corresponding tooth of the dental imaging image; and
(d) adding a marking showing the morphological structure of the tooth to the one or more intraoral videos or images
wherein the one or more intraoral videos or images are acquired using a mobile digital camera and a hollow tubular adapter, wherein a first opening of the hollow tubular adapter is configured to attach to the mobile digital camera, wherein a second opening of the hollow tubular adapter is configured to contact lips of the subject.

2. The method of claim 1, wherein the dental imaging image is selected from the group consisting of X-ray, magnetic resonance imaging (MRI), computed tomography (CT), transillumination, and fluorescent imaging.

3. The method of claim 1, wherein the matching in (c) comprises comparing a visible part of the tooth from the one or more intraoral videos or images to the dental imaging image.

4. The method of claim 1, wherein the matching in (c) comprises adjusting a visible part of the tooth from the one or more intraoral videos or images to match the tooth in the dental imaging image.

5. The method of claim 1, wherein the matching in (c) comprises adjusting the tooth from the dental imaging image to match a visible part of the tooth in the one or more intraoral videos or images.

6. The method of claim 1, wherein the matching in (c) comprises fitting a perspective of a visible part of a tooth in the one or more intraoral videos or images to the tooth in the dental imaging image.

7. The method of claim 1, wherein the matching in (c) comprises fitting a perspective of the tooth in the dental imaging image to a visible part of a tooth in the one or more intraoral videos or images.

8. The method of claim 1, wherein the morphological structure comprises at least part of at least one of a contour of the tooth or a root of the tooth.

9. The method of claim 1, wherein the marking in (d) of the morphological structure is added to the base of the one or more intraoral videos or images.

10. The method of claim 1, wherein the marking in (d) of the morphological structure is added on a layer, wherein the layer can be layered on top of the one or more intraoral videos or images.

11. The method of claim 1, further comprising adding at least part of at least one of a maxilla or mandible bone contour identified from the dental imaging image to the one or more intraoral videos or images.

12. The method of claim 1, further comprising adding at least part of a dental alveoli identified from the dental imaging image to the one or more intraoral videos or images.

13. A system configured to implement the method of claim 1.

14. A method to present a rendering of a root of a tooth of a subject, comprising:
(a) conducting a dental scan of a subject;
(b) processing the dental scan to identify a crown shape and location of at least one tooth;
(c) based on the crow n shape and the location of the tooth identified in (b), retrieving from a dataset comprising teeth morphological structures, a root shape with the greatest probability of matching the identified tooth; and
(d) adding the root shape to the identified tooth in the dental scan, thereby obtaining the rendering of the root of the tooth of the subject,
wherein the dental scan is acquired using a mobile digital camera and a hollow tubular adapter, wherein a first opening of the hollow tubular adapter is configured to attach to the mobile digital camera, and wherein a second opening of the hollow tubular adapter is configured to contact lips of the subject.

15. The method of claim 14, wherein in (c), the root shape is further based on root shapes that were previously identified as having greatest probability of matching the user.

16. The method of claim 14, wherein the adding in (d) comprises an assessment of unerupted teeth.

17. The method of claim 14, wherein the adding in (d) comprises an assessment of bone density.

18. The method of claim 14, wherein the adding in (d) comprises an assessment of least part of at least one of maxilla or mandible bone contour of the subject.

19. The method of claim 14, wherein the adding in (d) comprises an assessment of least part of a dental alveoli of the subject.

20. A system configured to implement the method of claim 14.
